(19) United States
(12) Patent Application Publication
(10) Pub. No.: US 2019/0141957 A1
(43) Pub. Date: May 16, 2019

(54) Leash Holder and Release System and Method

(71) Applicants: Andreas C. PFAHNL, Eden Prairie, MN (US); John J. ALLEN, Mendota Heights, MN (US); Troy J. ZIEGLER, Apple Valley, MN (US)

(72) Inventors: Andreas C. PFAHNL, Eden Prairie, MN (US); John J. ALLEN, Mendota Heights, MN (US); Troy J. ZIEGLER, Apple Valley, MN (US); Julianne CLEMENS, Lincolnshire, IL (US); Matthew JACKSON, Maple Grove, MN (US); Kathryn NELSON, Savage, MN (US); Kayla HODAPP, Lino Lakes, MN (US); Michael FRANCIS, Jordan, MN (US)

(21) Appl. No.: 16/096,196

(22) PCT Filed: May 11, 2017
(86) PCT No.: PCT/US17/32150

§ 371 Date: Oct. 24, 2018

Related U.S. Application Data
(60) Provisional application No. 62/335,628, filed on May 12, 2016.

(51) Int. Cl. A01K 27/00

(52) U.S. Cl. CPC A01K 27/005; A01K 27/003

(57) ABSTRACT

A method and system for providing remote or automatic release of a leash is disclosed. The release of the leash can be triggered by a remote user control, by a predetermined distance between the user and what is connected to the leash, or by various other means or events. The leash can be selectively released from a latch mechanism, from an integrally-attached spool housing, and the like.

### PRIORITY

This Application is a Section 371 US National Stage Application of PCT Application No. PCT/US17/32150, filed May 11, 2017, which claims priority to and the benefit of U.S. Provisional Patent Application No. 62/335,628, filed May 12, 2016; with each of the identified applications and disclosures incorporated fully herein by reference.

### FIELD OF THE INVENTION

The invention relates generally to leashes most suitable for pets and animals. More particularly, the invention discloses a device that attaches to a wearable device (e.g., collar or harness), stows and holds a leash, and uses electronics and other mechanisms to release the leash automatically under certain conditions, or by remote user control.

### BACKGROUND OF THE INVENTION

Leashes are used to control pets such as dogs and even cats, and other animals such as horses. A leash is generally clipped on to a collar or harness worn by the animal. Fixed length leashes are generally about 4 to 6 feet. If the leash is not kept taught, then it can droop and create slack. For some, the slack is undesirable because the tethered animal, and even the person holding the leash, are more prone to entangling themselves or objects in the leash. The person holding the leash must, therefore, constantly adjust the hold on the leash to keep the slack at an appropriate amount. A more convenient means to manage the leash length has been with retractable leashes.

Retractable leash holders have been developed that have an integrated mechanism (usually spring based) to retract the leash into a handle held by the person, such as those manufactured by flexi North America, LLC and FLEXI-BOGDAHN TECHNIK GMBH & CO. KG, or as described in references such as US 2005/010328 and US 2010/0018468. With the advent of portable electronics and wireless communication, the leash length and retraction can also be actively and remotely controlled as outlined in prior art US 2011/0120389 and US 2013/0340688. The leash retraction can also be integrated into a device worn by the animal like the Leashlocket sold by Leashlocket Ltd or the Anytime Collar by Anytime Pet Products, or as described in US 2011/0036304 and US 2013/0276717. However, even retractable leashes require the user to constantly hold and adjust the leash.

Other inventions have been described that make it more convenient for a person to remain tethered to the animal. There is a hands-free belt-attached leash described in US 2005/0229867 and a hands-free leg-attached device described in US 2011/0197824. However, all the methods that involve direct tethering and connection of the animal with a person suffer from the constant tugging and sometimes direction changes of a tethered animal.

Animals, particularly dogs and horses, can be trained well enough that they can accompany a person without a leash attached. Devices attached to the collar worn by the animal are described that provide stimulation to help with such behavioral training of the animal, and also as a backup measure to remind an animal to remain in close proximity. Examples of such references for use with dogs are described in US 2016/0015006 and US 2016/0015004. Examples of wireless stimulation training collar products for dogs can be found under the brand name PetSafe® sold by Radio Systems® Corporation, or multifunction ones as described in US 2015/0342150.

However, if the animal is distracted or disobedient and runs away then it becomes very difficult to catch the animal without a leash attached or retracted on the animal. A person may try to approach an animal and after a certain distance the animal then runs away again. This is problematic because animals are generally much faster than humans.

All of the aforementioned current fixed length and retractable leashes do not provide the ability to apprehend an animal not directly tethered to a person.

### SUMMARY OF THE INVENTION

The present invention solves the issues of many of the drawbacks mentioned herein by providing a means to stow a leash on the animal to remain untethered to a person, such that a person can automatically, or by remote control, release or deploy the leash at an appropriate time. There is a need to be able to stow a leash on an animal and at the appropriate time deploy the leash so that it drags behind the animal. If the free animal has a leash attached it becomes much easier to apprehend the animal. For instance, if an animal with a dragging leash stops running for a moment, and a person then approaches the animal, they do not need to approach as closely anymore (e.g., only to the end of the extending leash). The animal will not feel as threatened and run when there is a larger distance to the person. If an animal is running past a person with a leash trailing behind, it is possible and quite easy to grab or stomp on the end of the leash rather than trying to get right up to the animal and directly grab it. Also, if the animal runs free into a wooded area or an area full of brushes then there is a chance the leash can get entangled in branches and stop the animal so the person can catch up and regain hold of the leash. Retractable leashes worn on the animal like those identified herein (e.g., US 2011/0036304 and US 2013/0276717), or ones that require manually stowing of the leash like US 2004/0180590, do not provide a means to automatically release the leash.

With this invention, an animal can remain untethered to a person. If the animal is staying in close proximity to the person but then for some reason runs way from that person, the leash can be selectively ejected. This is done by the person using a remote control or with on-board sensors that can automatically detect a maximum distance (from the user) has been exceeded. The user remote control can be a key fob, a smartphone or mobile device, etc.

In a first embodiment, the invention is a device with a module that clips to the wearable collar that an animal wears, and the device can include a latch integrated with a strap. The collar in various embodiments can be or include a harness. A conventional leash can be attached to the collar of an animal, and the leash is manually bundled together. The latching strap wraps around the bundled leash and is latched into the module.

In a second embodiment, the latch is integrated with a leash that is stowed in an integrally-attached spool type housing. This approach keeps the leash more confined and organized in the stowed state.

There can be any number of different latching mechanisms or actuators but in various embodiments a motor is used to rotate a threaded shaft onto which the latch mechanism connects. The module includes electronics that control the motor and provide wireless communication to an external remote control. In a first mode of operation, the external remote control can be used by a person to activate the motor, which then disengages the latching strap and thereby releases the leash. In a second mode of operation, the electronics module regularly checks to ensure communication with the remote control. If communication is lost because, for instance, the communication distance is exceeded (or simply indicates a predefined distance threshold) then the electronics module automatically activates the motor to disengage the latching strap, thereby releasing the leash. The predefined or communication distance can vary greatly. In certain embodiments, the distance can be between 5 feet and 10 feet.

Various embodiments can include a set of magnets instead of a threaded screw. Other embodiments can include a solenoid instead of a motor to provide the desired actuation and release. Other mechanisms, devices, actuators, and techniques can be employed without deviating from the spirit and scope of the present invention.

### BRIEF DESCRIPTION OF THE DRAWINGS

FIG. 1 is a schematic representation of an embodiment of the present invention used with a dog.

FIG. 2 is a front perspective detail view of an embodiment of the present invention with the latching strap disengaged from the latch box.

FIG. 3 is a rear perspective view of the embodiment of FIG. 2 with the latching strap engaged with the latch box that has the rear cover removed.

FIG. 4 is a close-up top view of the embodiment of FIG. 2 and FIG. 3 with the latch mechanism shown in section.

FIG. 5 depicts a method embodiment of the present invention.

FIG. 6 shows an embodiment of the present invention with an integrated rope leash wound onto a spool and engaged with the latch box.

FIG. 7 shows the embodiment of FIG. 6 with the leash unwound and the spool disconnected from the latch box.

FIG. 8a-9 show embodiments of the present invention including a linear actuator, such as a solenoid, to release the bundled leash.

FIG. 10 shows an embodiment of the present invention including a motorized linear actuator to release the bundled leash.

FIG. 11 shows an embodiment of the present invention including suction and fluid control to release the bundled leash.

### DETAILED DESCRIPTION

Exemplary embodiments of the present invention are described in the following with reference to the drawings. It should be understood that such embodiments are by way of example only and merely illustrative of the many possible embodiments which can represent applications of the principles of the present invention. Various changes and modifications obvious to one skilled in the art to which the present invention pertains are deemed to be within the spirit, scope, and contemplation of the present invention as further defined in the appended claims. The exemplary embodiments of the present invention described herein are not intended to be exhaustive or to limit the present invention to the precise forms disclosed in the following detailed description. Rather, the exemplary embodiments described herein are chosen and described so those skilled in the art can appreciate and understand the principles and practices of the present invention.

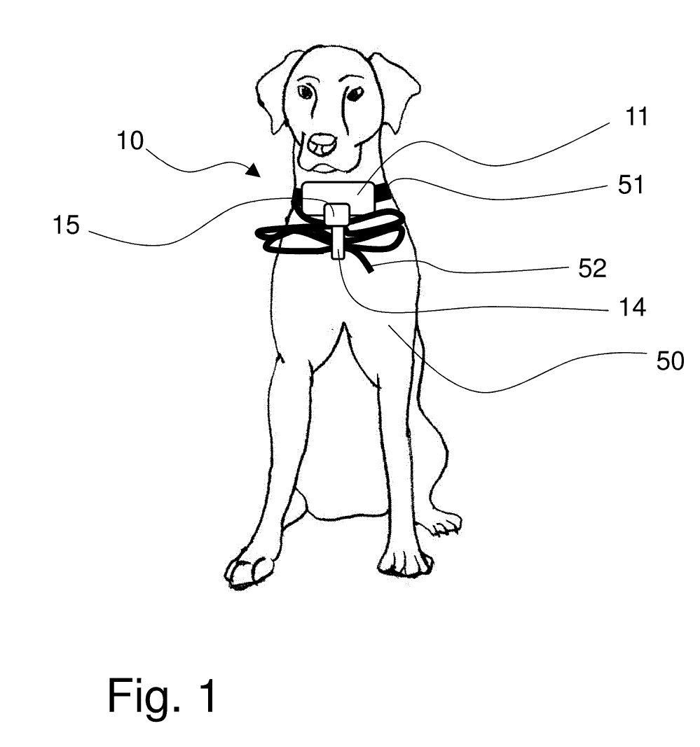

Referring to FIG. 1, a first embodiment of the invention 10 is shown. The device 10 can include a latch box 11 that clips on to an animal collar, which in FIG. 1 is a dog 50 with a conventional collar 51. In various embodiments, the collar can be or include a harness or other wearable device. A conventional fixed-length leash 52 is shown and is directly connected to the collar 51. The leash 52 is shown bundled up with strap 14 of the device 10, which is affixed on one end to the latch box 11 and on the other end to latch assembly 15, which itself is engaged and latched to the latch box 11. When the latch box 11 is activated, the latch assembly 15 disengages from latch box 11 and thereby releases the leash 52. The invention is now described in further detail in addition to other embodiments and the methods of a collar-worn remotely releasable leash holder.

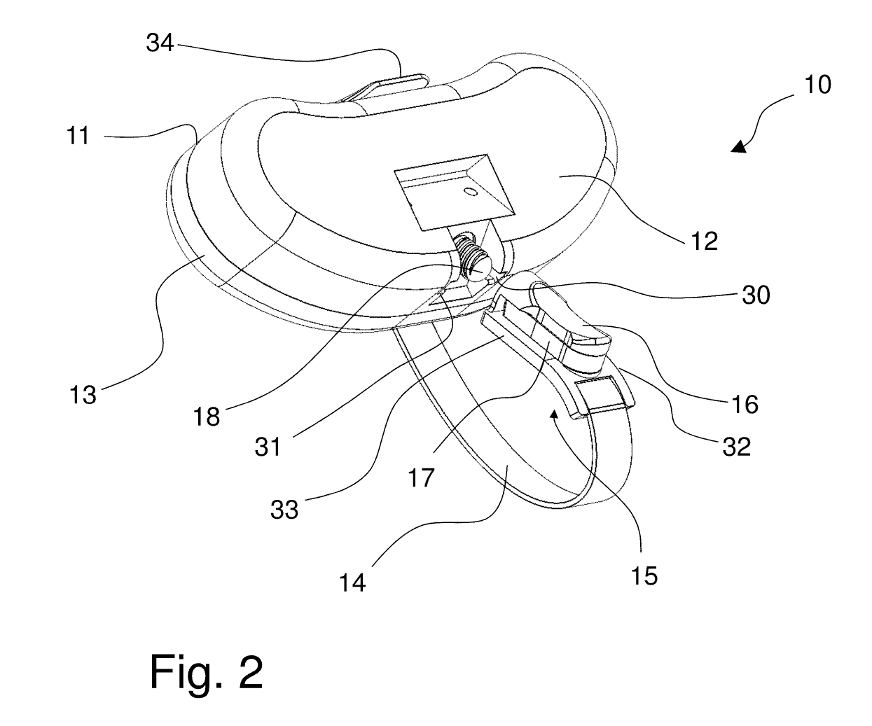

Now referring to FIG. 2, a close-up of the embodiment of the device 10 of FIG. 1 is shown with the latch assembly 15 disengaged from the latch box 11, which has a clamshell type enclosure including a front cover 12 and a rear cover 13. Clip 34 is used to attach the device 10 to a wearable 51, as shown in FIG. 1. The strap 14 can be constructed of an elastic rubber, or other desirable or expandable materials, to accommodate different bundled leash sizes. The latch assembly 15 can be comprised of two primary components, a housing 16 and a spring 17. Fasteners to hold the spring 17 to the housing 16 are not shown for illustration simplification but can be included with the device 10 as well. The housing 16 can include guides 32 and 33 that align with tracks 30 and 31 of the front cover 12. When a user pushes latch assembly 15 into the latch box 11, so that the guides 32 and 33 engage tracks 30 and 31, the tips (not seen in this figure) of spring 17 will engage the threads of threaded shaft 18 like a nut on a screw, and thereby keep the two interlocked together. By rotating threaded shaft 18, the latch assembly 15 can then be unthreaded and disconnected from threaded shaft 18 so that it disengages from the latch box 11.

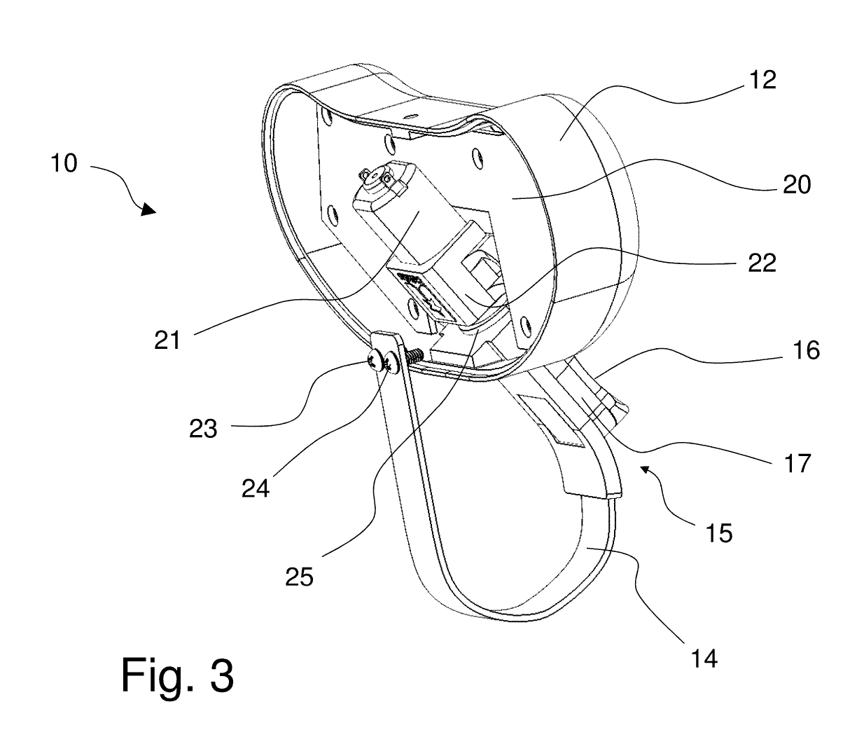

FIG. 3 shows a rear view of the embodiment of the device 10 with the latch assembly 15 engaged and latched to the latch box 11. The rear cover 13, shown in FIG. 2, is omitted in this figure to make the main internal components of latch box 11 visible, which include a main printed circuit board assembly (PCBA) 20, a motor 21, a motor clamp 22, and a bearing 25. Screws 23 and 24 are used to fasten the strap 14 to the rear cover 13. The housing 16 and spring 17 of latch assembly 15 are visible as well, and engaged with the front cover 12 and threaded shaft 18 (not visible in this figure), respectively.

The motor clamp 22 is used to hold motor 21 to the inside of the front cover 12. The shaft of the motor 21 is directly connected to threaded shaft 18 and provides the means to rotate the threaded shaft 18 to disengage the latch assembly 15 from the latch box 11. The motor 21 requires power and electronics to operate, which is provided by the PCBA 20. PCBA 20 can include various electronics and components, such as a microcontroller, a wireless or field communication module so that it can be remotely actuated and controlled, at least one LED or like component that is externally visible for indicating adequate battery charge level, and at least one battery (rechargeable or replaceable) for power.

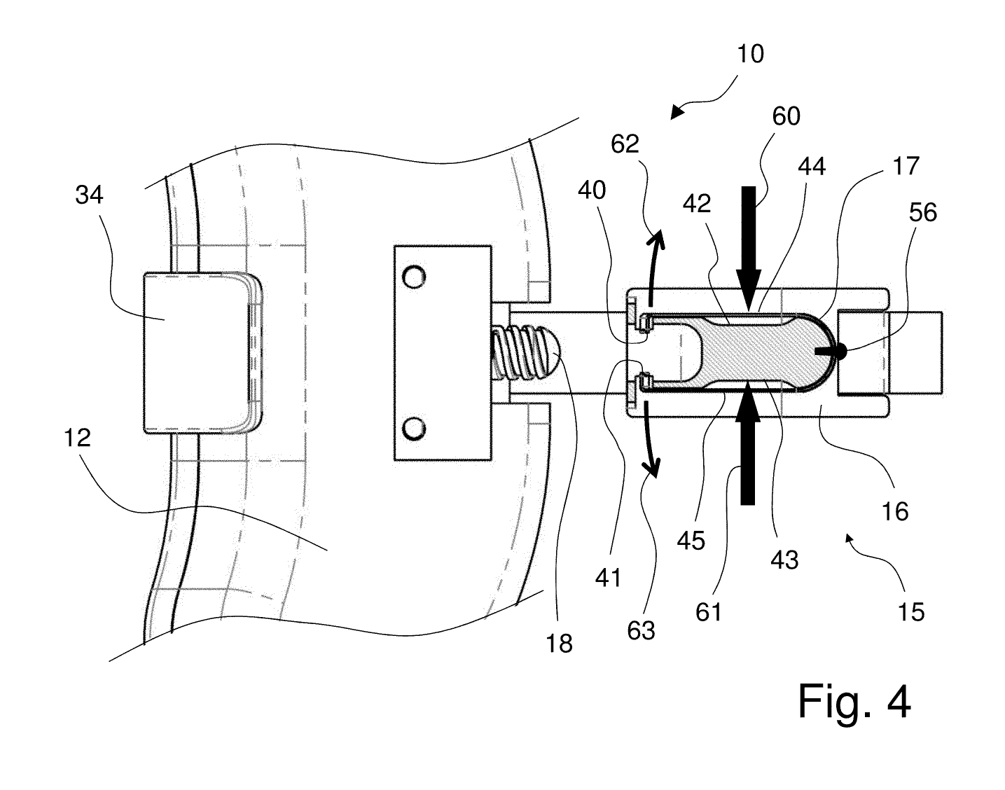

FIG. 4 shows a top view of the embodiment of the device 10 with a section view of the latch assembly 15 that depicts the tips 40 and 41 of spring 17, the recessed walls 42 and 43 of housing 16, and the sides 44 and 45 of spring 17. The clip 34 and front housing 12 are identified for reference. Spring 17 is fastened to housing 16 with screw 56 at the rear of the housing 16. A user can actuate the spring 17 by applying a force 60 and 61 to the sides 44 and 45 of spring 17 so they deflect toward walls 42 and 43, respectively. This action causes the tips 40 and 41 to then deflect outward as shown by arrows 62 and 63, thereby disengaging from the threads of threaded shaft 18.

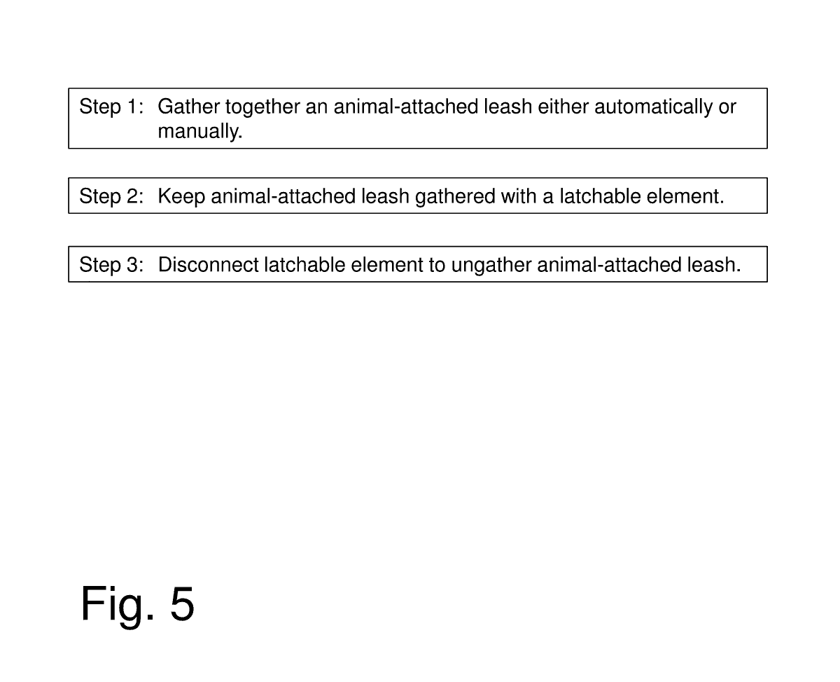

FIG. 5 details a method of operation for the present invention. Step 1 is identified where a leash connected to an animal is gathered together by, for example, a manual process of bundling a fixed length leash (e.g., like that shown in FIG. 1), or by the spooling of a cord-like leash using a retraction mechanism with external leash retractors. Step 2 is identified where the gathered animal-attached leash is kept gathered on the animal using a latchable element that can connect and disconnect from an animal-worn device. Finally, Step 3 describes where the latchable element disconnects and thereby releases the leash remotely (e.g., by wireless control), or automatically (e.g., by a preset function), with an end of the leash remaining connected to the animal.

The use of the device 10 is best illustrated by an exemplary use description with reference to the previously described figures, in which the device 10 communicates with a user-controlled smartphone (or other mobile or like device) by wireless communication (e.g., Bluetooth). Other wireless communication protocols and techniques are also envisioned for use and implementation with the present invention. Consider the start condition where the application software (App) for communicating with the device 10 is not active or on, and the latch assembly 15 is disconnected. The device 10 can be powered down automatically by its controller into a low-power sleep mode. A user then bundles up a leash 52 and wraps the strap 14 around it and connects the latch assembly 15 into the latch box 11. The latch box 11 includes one or more sensors that detect the engagement of the latch assembly 15, causing the device to “wake up” or power up. A power-down timer or sleep timer can initiate and the controller looks for connection to the user's smartphone. The user is allowed a certain amount of time to launch the App and connect with device 10. If the connection is successful in this prescribed time limit, then the device 10 stays connected and monitors connection periodically. If the connection is lost (e.g., out of range from the user's smartphone), then the motor 21 of the device 10 is activated for a defined time period that ensures the latch assembly 15 disengages from the latch box 11. This causes the leash 52 to unbundle and drag behind the animal, since one end of the leash 52 is still connected to the animal. The device 10 can then power down and go back into a sleep mode to conserve power. If connection with the smartphone App is not successful in the prescribed time limit, then the device 10 activates the motor 21 again to disengage the latch assembly. The device 10 can then power down again and go back into its sleep mode to conserve power. In these scenarios, the device end state is the sleep mode with the latch disconnected, which is also the device start mode. The device will wake up when the latch is connected again by user. The device 10 can also include light indicators (or other visual indicia) or communicate to the App the battery capacity level so that the user knows when to replace or recharge the batteries of the device 10.

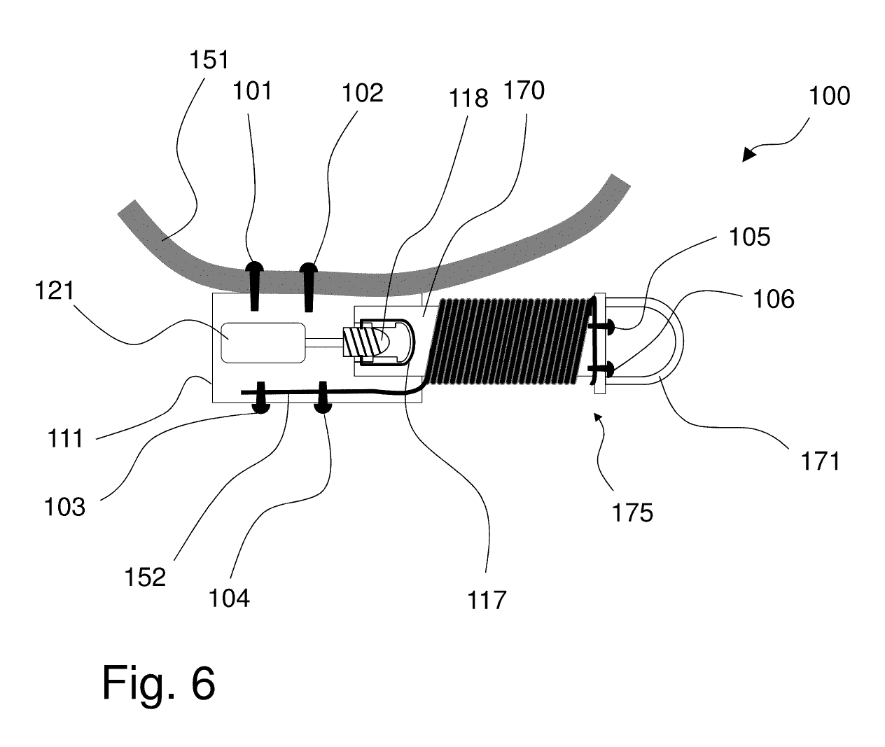

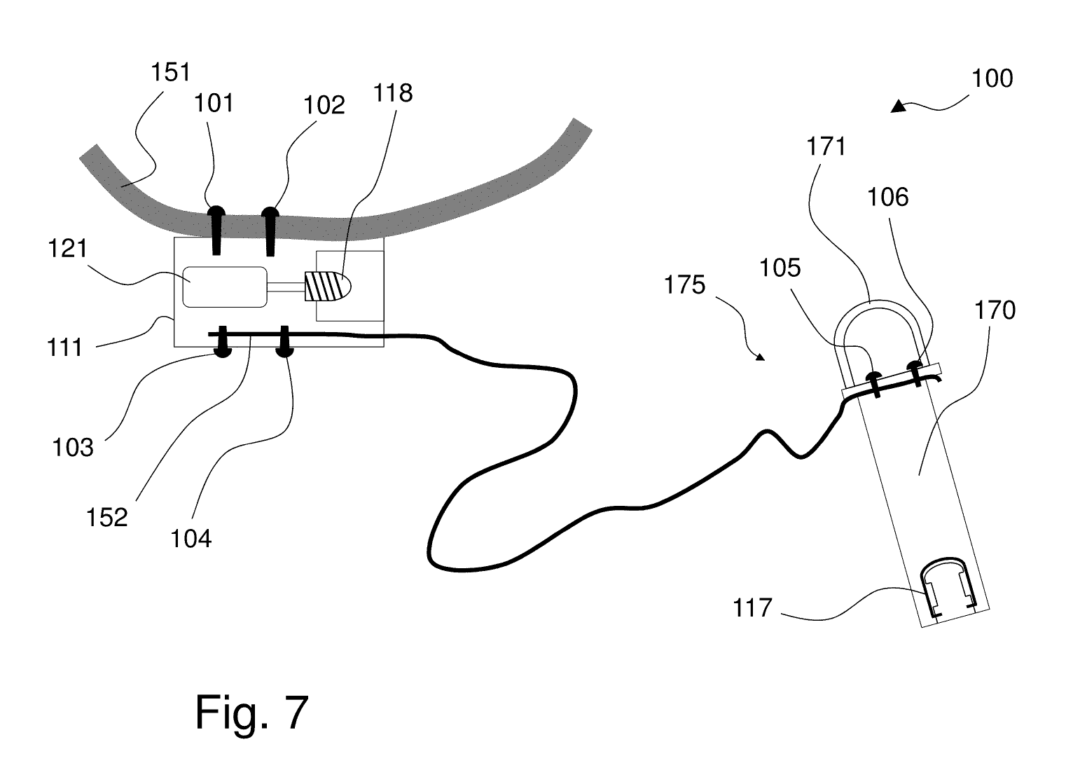

An alternative embodiment of the invention is shown in FIGS. 6 and 7 as device 100. Device 100 can include a latch box 111, in this case affixed to a wearable 151 with screws 101 and 102. This type of attachment is more secure since in this case the leash 152 is affixed to latch box 111 shown using screws 103 and 104. The device 100 includes motor 121 connected to threaded shaft 118. Leash 152 is wound onto the shaft 170 of spool assembly 175, with its other end affixed to the handle 171 of the spool assembly 175 with screws 105 and 106. Spool assembly 175 includes a latching spring 117 that engages with the threaded shaft 118 when the spool assembly 175 is engaged into latch box 111. The fasteners are described here as screws but can be any means of affixing the components together—e.g., any acceptable fasteners or devices. FIG. 6 shows the spool assembly 175 engaged with the latch box 111, and FIG. 7 shows it disengaged from the latch box 111 and the leash 152 unwound.

The before-mentioned embodiments utilize a threaded screw and spring-latch type mechanism, but other latching mechanisms are envisioned for use with the present invention, including merely using magnets or like devices and components. Also, various embodiments have been illustrated with components necessary to describe the invention, but they do not necessarily represent all the components needed to manufacture the device. In addition, there may be additional components incorporated to enhance the functions of the device but that do not change the key inventive aspects of the device. For instance, the spool assembly 175 described in FIGS. 6 and 7 may include a cylindrical cover. The latch boxes 11 or 111 may incorporate an additional spring to help disconnect the latch assembly 35 or spool assembly 175, respectively.

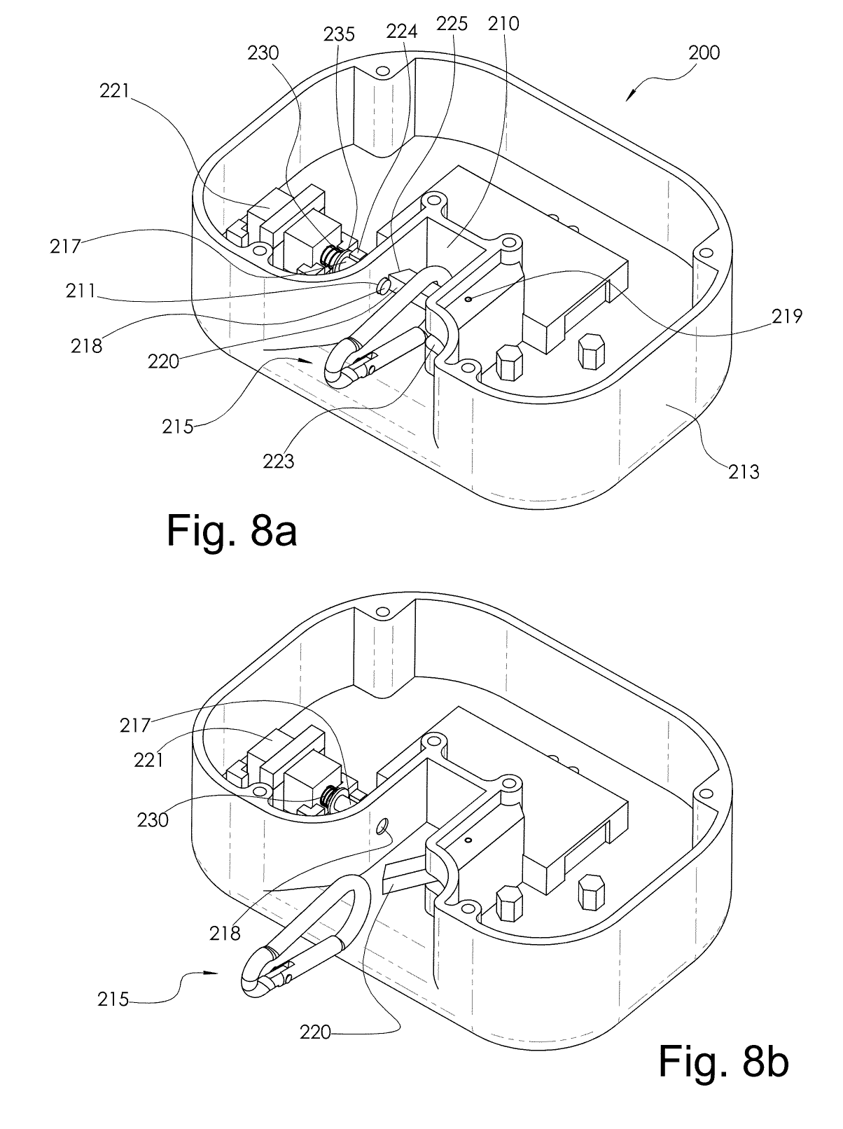

An alternate embodiment shown in FIGS. 8a and 8b uses a linear actuator, such as a solenoid, to release the bundled leash. Device 200 includes a housing 213 in which the solenoid body 221 and the plunger 217 are mounted. A biasing spring 230 pushes against ring 235 on plunger 217, until ring 235 rests against a stop 224 on housing 213. The plunger end 218 is thereby forced to project through an aperture 211 in the housing. Lever 220 is attached to housing 213 at pivot 219, and is adapted to rotate about the pivot 219, within slot 223. The ramped end 224 on the lever 220 can push against the plunger end 218, displacing plunger 217 and allowing lever 220 to rotate into a locked position that prevents reversal of the rotation. With lever 220 in a locked position, a common carabiner 215 (or similar mechanism such as a leash clip or the like) can be attached onto lever 220. The leash holding strap (not shown) would attach at one end to carabiner 215, and to device 200 at its other end such that it can hold a bundled leash.

Referring to FIG. 8b, when solenoid 221 is energized, an electromagnetic force pulls plunger 217 toward it and against spring 230, causing plunger end 218 to retract away from lever 220. This allows lever 220 to freely pivot and in turn allows carabiner 215 to fall away. Although a solenoid is depicted in this embodiment, mechanical actuators such as a motor and leadscrew, a rack and pinion arrangement, pneumatic vacuum actuators, or other like mechanisms can achieve similar desired actions, and can be employed, as plunger end 218.

FIG. 9 shows device 300, an alternate embodiment with a housing 313 into which solenoid body 321 and plunger 317 are mounted. A biasing spring 330 pushes against ring 335 on plunger 317. A slidable catch 320 is attached to the end of the plunger 317 and is constrained to move with it. An insertable pin 315 can pass through a hole 311 in housing 313 and pushes catch 320 and plunger 317 linearly against spring 330 as it passes through slot 325 on catch 320. Although slot 325 is larger than pin 315, its end radius is not aligned with the center of hole 311. Thus, when groove 326 on pin 315 reaches the position of slot 325, the biasing spring 330 pushes catch 320 toward groove 326, thereby locking it in position. The leash holding strap (not shown) can attach at one end to loop 316, and to device 300 at its other end such that it can hold a bundled leash. When pin 315 is locked within device 300, solenoid 321 can be energized such that an electromagnetic force pulls plunger 317 and catch 320 away from groove 326. This allows pin 315 to fall out of hole 311 and drop the bundled leash. Manual release of pin 315 can be performed by pushing the external button 350 on the pusher 345, such that the ramp 340 slideably contacts ramp 324 on catch 320. This forces slot 325 away from groove 326, allowing pin 315 to fall out.

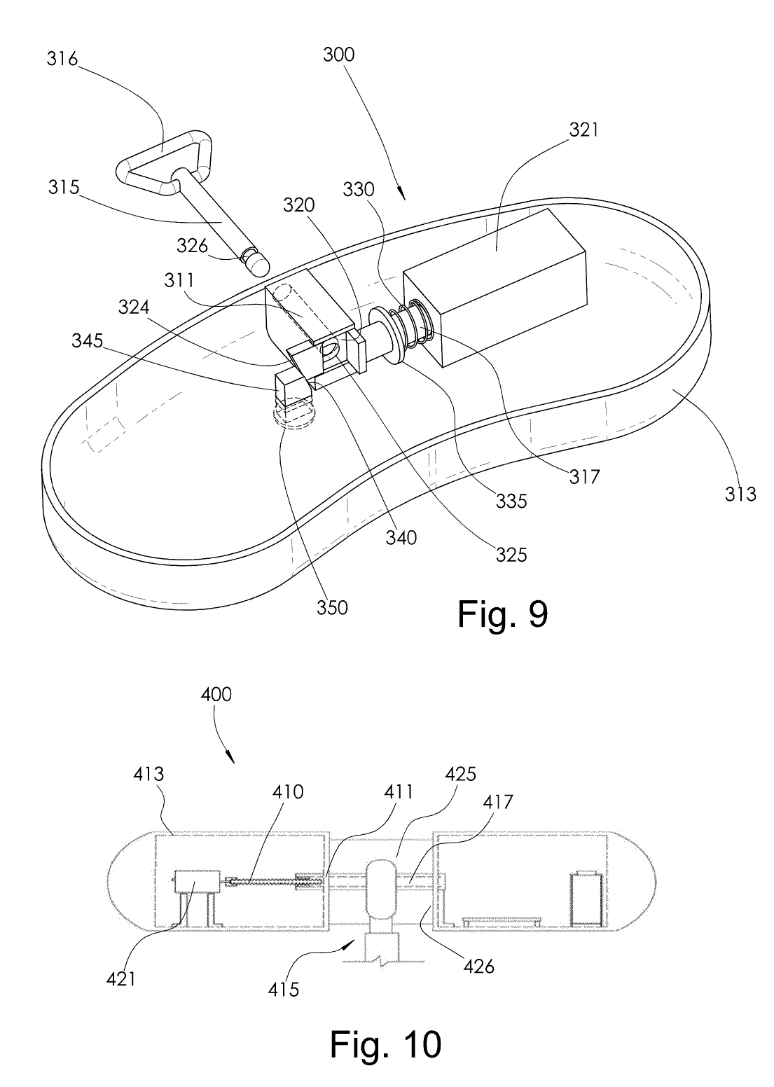

FIG. 10 depicts a device 400, which is an embodiment of the present invention that includes a linear actuator to release the bundled leash. The device 400 includes a housing 413 in which a motor 421 turns threaded shaft 410, which then drives an arm 417 through an aperture 411 in the housing. Arm 417 extends across an opening 425 until it is in close proximity to a stop 426. With arm 417 in this position, a common carabiner 415 (or similar mechanism such as a leash clip or the like) can be attached onto arm 417. The leash holding strap (not shown) would attach at one end to the carabiner 415, and to the device 400 at its other end such that it can hold a bundled leash. As motor 421 drives arm 417 away from stop 426, the carabiner 415 falls away. Although a motor is depicted in this embodiment, mechanical actuators such as a solenoid, a rack and pinion arrangement, pneumatic vacuum actuators, or other like mechanisms can achieve similar desired actions, and can be employed, with arm 417.

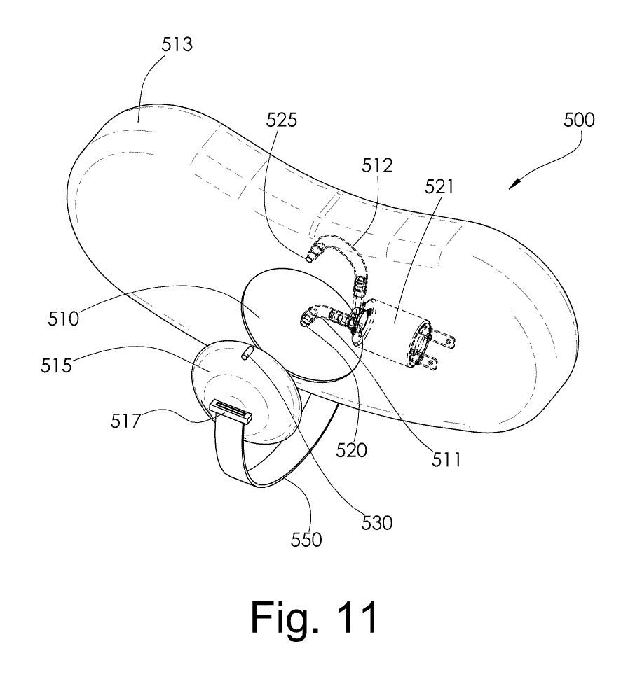

FIG. 11 shows a device 500, which utilizes a suction cup 515 that can mount to face 510 on housing 513. The leash holding strap 550 attaches at one end to tab 517 on suction cup 515, and to housing 513 at its other end such that it can hold a bundled leash. Vent port 520 lies on face 510 and creates an air or fluid channel through the wall of housing 513 that continues through inlet tube 511. An exhaust port 525 is positioned on an external surface of housing 513 that does not get covered by suction cup 515, and creates an air or fluid conduit through the wall of housing 513 that continues through outlet tube 512. Inlet tube 511 and outlet tube 512 each connect to a valve 521 that controls air or fluidic flow between tube 511 and tube 512 (these components are internal to housing 513 and appear in phantom lines in the drawing). The valve mechanism 521 may be, for example, a commercially available solenoid valve. When suction cup 515 is pressed onto face 510, valve 521 is in the closed position, blocking the flow of air from port 525 to port 520, and suction cup 515 remains attached. An optional sensor, measuring the pressure on the vent port side of valve 521, can be implemented for the purpose of detecting the presence or absence of suction cup 515. On command, valve mechanism 521 is electronically switched to the open position, allowing air to vent from port 525 to port 520 and causing the suction cup to fall off and release the bundled leash. Manual release of the bundled leash can be performed by lifting away nub 530 at the edge of suction cup 515. An advantage of this embodiment is that no moving components pass through the walls of the housing, thereby making it easier to seal the housing and limit fluid ingress. A further advantage is that it uses very few moving parts and is therefore smaller and less likely to experience mechanical failure.

For clarity, the embodiments shown in FIGS. 8-11 depict the components essential for describing the leash strap holding or latching mechanism. Other components, such as batteries, circuit boards, controllers, wiring, covers, and other components, devices, assemblies, and mechanisms (known or as described herein) can be included and employed for each embodiment of the present invention. In addition, various plastics, metals, and like materials can be used to form or construct all or parts of various portions or components of the present invention.

As detailed herein, one or more modules can include electronics that control the motor and provide wireless communication to an external remote control. In a first mode of operation, the external remote control can be used by a person to activate the motor, which then disengages the latching strap and thereby releases the leash. In a second mode of operation, the electronics module regularly checks to ensure communication with the remote control. If communication is lost because, for instance, the communication distance is exceeded (or simply indicates a predefined distance threshold) then the electronics module automatically activates the motor to disengage the latching strap, thereby releasing the leash. The predefined or communication distance can vary greatly. In certain embodiments, the distance can be between 5 feet and 10 feet.

While embodiments and exemplary features of the present invention have been described for use with dogs or other pets, this is for illustrative and descriptive purposes only. Use or implementation with humans, other animals, and the like are also envisioned and do not limit or deviate from the spirit and scope of the present invention.

The present invention has been described with reference to exemplary embodiments thereof. The entire disclosure of any patent or patent application identified herein is hereby incorporated by reference for all purposes. The foregoing disclosure has been provided for clarity of understanding by those skilled in the art. No unnecessary limitations should be taken from the foregoing disclosure. It will be apparent to those skilled in the art that changes can be made in the exemplary embodiments described herein without departing from the scope of the present invention. Thus, the scope of the present invention should not be limited to the exemplary structures and methods described herein, but only by the structures and methods described by the language of the claims and the equivalents of those claimed structures and methods.

What is claimed is:

1. A leash holder and release system, comprising:
a leash device;
a release mechanism operatively connected to a bundled leash; and
an actuation mechanism in operative communication with the release mechanism and adapted to release a length of the bundled leash.

2. The system of claim 1, wherein the actuation mechanism includes a motor.

3. The system of claim 1, wherein the actuation mechanism includes a solenoid.

4. The system of claim 1, further including a remote device in operative communication with the actuation mechanism to provide selective actuation.

5. The system of claim 4, wherein the remote device is a mobile user device.

6. The system of claim 5, wherein the mobile user device is a smartphone capable of running an application to facilitate the selective actuation.

7. The system of claim 1, further including a remote device and a controller in operative communication with at least the actuation mechanism.

8. The system of claim 7, wherein the release of the length of the bundled leash triggers automatically when the remote device is a predefined distance away from the leash device.

9. The system of claim 1, wherein the actuation mechanism includes a linear actuator.

10. The system of claim 1, wherein an end portion of the bundled leash remains connected to the leash device or an animal wearable.

11. A leash holder and release system, comprising:
a leash device;
a release mechanism operatively connected to a bundled leash;
a controller;
a remote device in operative communication with the controller; and
an actuation mechanism in operative communication with the release mechanism and adapted to release a length of the bundled leash.

12. The system of claim 11, wherein the actuation mechanism includes a motor.

13. The system of claim 11, wherein the actuation mechanism includes a solenoid.

14. The system of claim 11, wherein the remote device is a mobile user device.

15. The system of claim 14, wherein the mobile user device is a smartphone capable of running an application to facilitate selective actuation.

16. The system of claim 11, wherein the release of the length of the bundled leash triggers automatically when the remote device is a predefined distance away from the leash device.

17. The system of claim 11, wherein the actuation mechanism includes a linear actuator.

18. The system of claim 11, wherein the actuation mechanism includes a suction and pneumatic mechanism.

19. The system of claim 11, wherein an end portion of the bundled leash remains connected to the leash device or an animal wearable.

20. The system of claim 19, wherein the animal wearable is a collar or a harness.
